(19) United States
(12) Patent Application Publication
(10) Pub. No.: US 2015/0371458 A1
(43) Pub. Date: Dec. 24, 2015

(54) MOBILE COMPUTER PERIPHERAL

(71) Applicant: Precision Mounting Technologies Ltd., Calgary (CA)

(72) Inventor: Miles Lane Scott, Calgary (CA)

(21) Appl. No.: 14/743,626

(22) Filed: Jun. 18, 2015

Related U.S. Application Data
(60) Provisional application No. 62/014,011, filed on Jun. 18, 2014.

(51) Int. Cl. G07C 5/00; G07C 5/08; G01V 8/10; G01S 19/13

(52) U.S. Cl. CPC G07C 5/008; G01S 19/13; G07C 5/0808; G01V 8/10

(57) ABSTRACT

A peripheral for a mobile computer mounted to a vehicle, the peripheral including a microcontroller; and a sensor; wherein the peripheral has a communications link to the computer and the peripheral is attached to the vehicle; and wherein the microcontroller is configured to receive data from the sensor and process the data for the computer.

This application claims the benefit of U.S. Provisional Patent Application Ser. No. 62/014,011 filed Jun. 18, 2014, which is hereby incorporated by reference in its entirety.

### FIELD

The invention relates to peripherals for mobile computers, and more particularly to peripherals for computers that are used in vehicles.

### BACKGROUND

Mobile Computers have been used, mounted or unmounted, in vehicles for over 30 years. Mobile computer systems are deployed in large numbers to collect and report data from vehicles in locations generally outside the physical buildings of an organization. A few examples include public service vehicle fleets such as first responders, e.g. police agencies, Emergency Medical Services (EMS), and fire departments; and non-emergency services e.g. road and highway inspectors, mapping teams, and building inspectors. Other deployments occur in commercial fleets such as freight and delivery businesses and service teams, for example insurance adjusters, mobile service trucks, and field measurement or installation teams.

A common problem in these deployments is the choice between using a Commercial Off The Shelf (COTS) general purpose (GP) computer or a custom designed computer to meet the mission requirement for data collection. Once the computer has been selected it is most often the case that additional needs or opportunities arise to collect additional data; however, the data processing capability and/or interface resources of the computer may not be able to fulfill these requirements or take advantage of these opportunities.

Modems and other peripherals have been interfaced to these computers to allow the computers to send and receive data to and from a remote location, and to print, speak, or interface with the user and/or a vehicle network. Sensors have been built into some of these Mobile General Purpose Computers (MGPCs), including accelerometers, gyros, and thermocouples; however these installations have followed the standard computing model of sending raw data to a general purpose computer for processing and action using a computer program which is sharing the resources of that same general purpose computer.

Processor elements have been added to some sensors to handle digital communication of data and identify when thresholds have been tripped. However, these systems are not programmable for specific applications without changes in the manufacturing process as these processing units are hard wired in the production process to respond to a small set of binary values that turn on and of segments of the sensor or set thresholds.

### SUMMARY

A peripheral for a mobile computer mounted to a vehicle, the peripheral including a microcontroller; and a sensor; wherein the peripheral has a communications link to the computer and the peripheral is attached to the vehicle; and wherein the microcontroller is configured to receive data from the sensor and process the data for the computer. The peripheral may include a discrete memory for storing data from the sensor and the mobile computer and the peripheral may be attached to the vehicle using a frame.

The peripheral receives and analyzes data through calculation of a decision algorithm. When the decision indicates that actionable or interesting data is available the peripheral opens communication with the computer to provide processed and analyzed data to the operator. This significantly reduces the computing work load of the host computer and increases its functionality.

The sensor may be a thermocouple; an alcohol, CO or other gas detector; a radiation detector, a light meter; an accelerometer; a GPS receiver; an on board diagnostic system; an inertial measurement and location system; or a security system.

The microcontroller may determine motion of the vehicle based on input from the sensor, in which case the microcontroller signals the computer, and the computer is configured to turn off the screen of the computer on receipt of the signal.

The microcontroller may determine an abnormal incident has occurred based on input from the sensor, in which case the microcontroller signals the computer, and the microcontroller stores data from the sensor for later access.

The microcontroller may store sensor data for later use in determining driver performance.

The security system may be a finger print scanner, a RFID chip reader or a keypad.

### BRIEF DESCRIPTION OF THE DRAWINGS

FIG. 1A is a block diagram of an embodiment of a computer peripheral according to the invention.

FIG. 1B is a block diagram of an alternative embodiment of a computer peripheral according to the invention.

FIG. 2 is a block diagram showing the computer peripheral within a vehicle.

FIG. 3 is a perspective view of an embodiment of a peripheral and computer according to the invention.

FIGS. 4A and 4B are perspective and blown up views, respectively of an embodiment of a peripheral according to the invention.

### DETAILED DESCRIPTION

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise. The term “plurality” means “two or more”, unless expressly specified otherwise. The term “herein” means “in the present application, including anything which may be incorporated by reference”, unless expressly specified otherwise.

The term “e.g.” and like terms mean “for example”, and thus does not limit the term or phrase it explains.

The term “peripheral” means an auxiliary device that connects to and works with a computer in some way.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

Where two or more terms or phrases are synonymous (e.g., because of an explicit statement that the terms or phrases are synonymous), instances of one such term/phrase does not mean instances of another such term/phrase must have a different meaning For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. Section 1.72(b) or similar law in other jurisdictions. The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

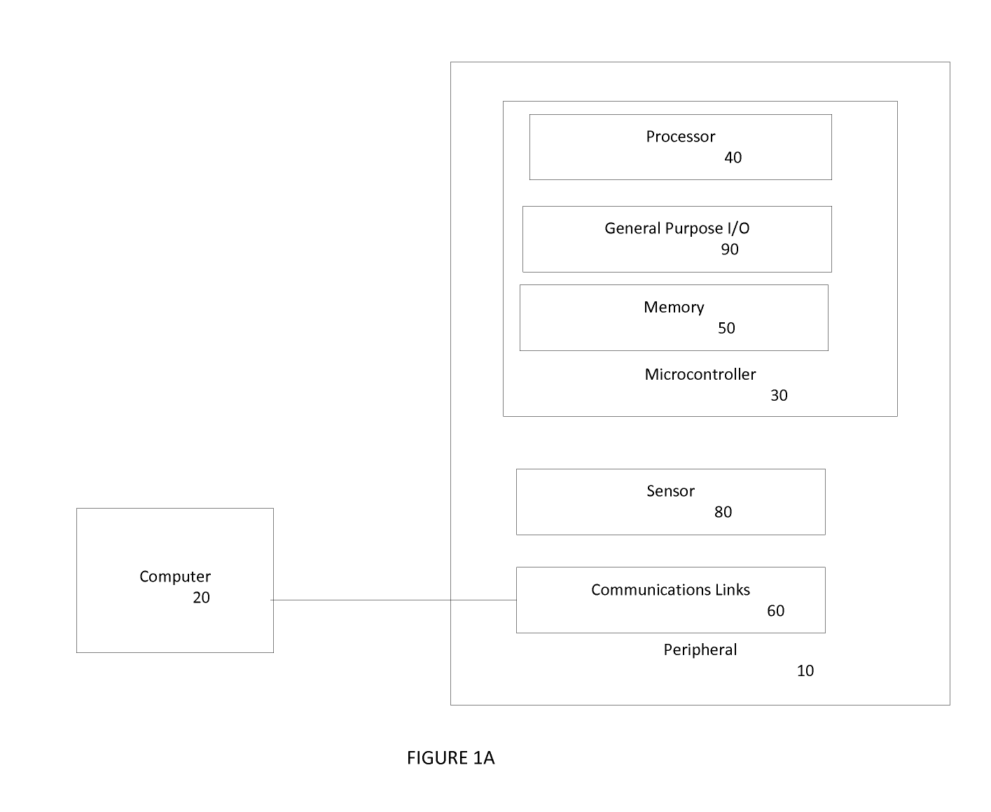

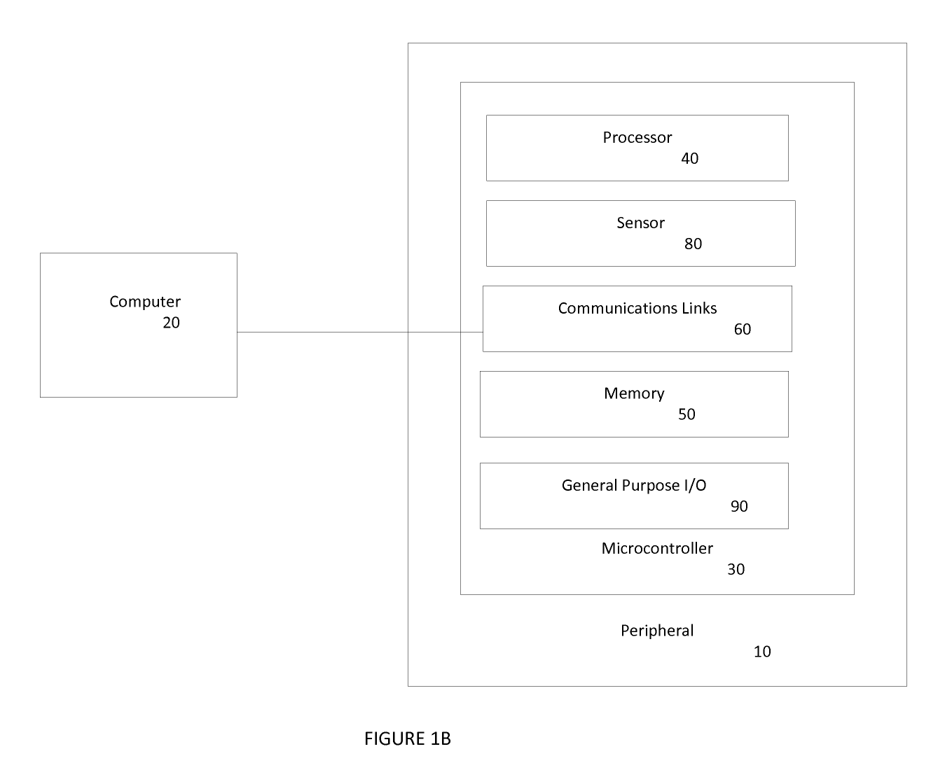

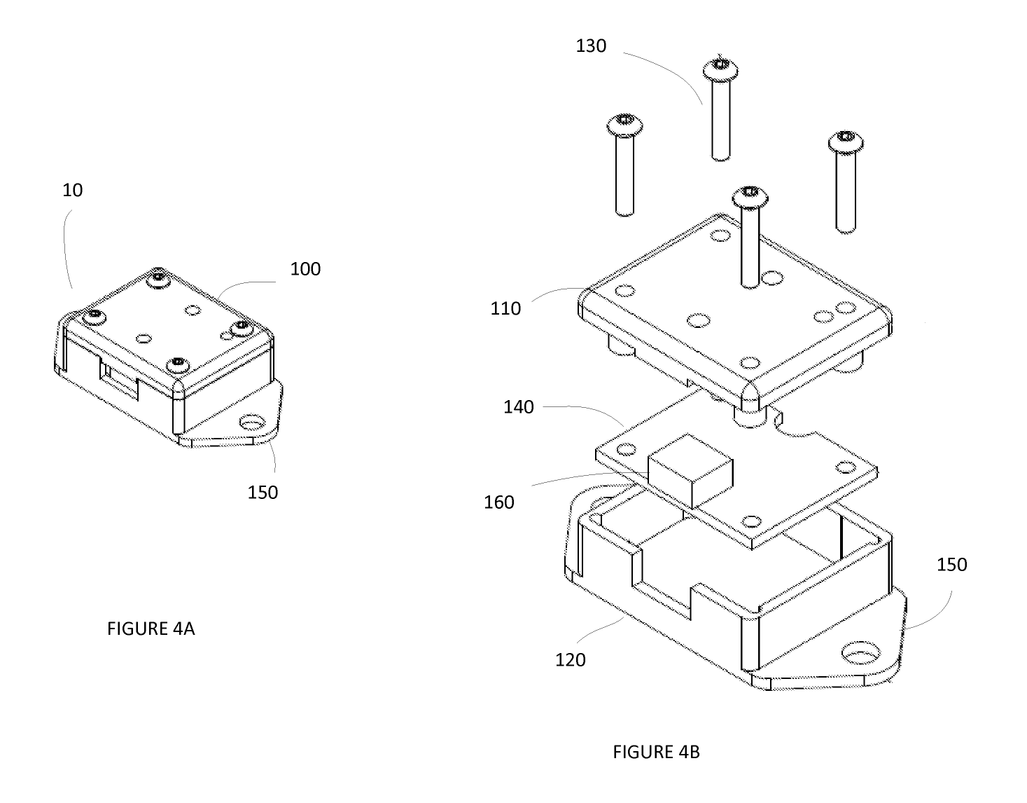

As shown in FIG. 1A and 1B, the system and method according to the invention provides a smart sensor appliance or peripheral 10 for a mobile computer system 20 used in a vehicle 70. The peripheral 10 acts as a Programmable Modular Sensor System (PMSS) that may be attached to a mobile general purpose or custom designed computer 20 as a smart appliance or peripheral. An example of the peripheral 10 as a PMSS is shown in FIGS. 4A and 4B. The embodiment of the invention may include one of more of the components described below.

The peripheral 10 includes a microcontroller 30, including a processor 40, General Purpose Input/Output interface 90, memory 50 and a communications link 60 to computer 20. The peripheral 10 is configured to execute a special purpose program (which may be implemented as firmware). The microcontroller 30 does not need to use a general purpose operating system but may rather execute a set of instructions in a continuous loop whenever powered. In contrast to the general purpose computer 20 with an operating system which may have tens or hundreds of general purpose algorithms running or waiting at any given time to service the user, microcontroller 30 has one or a few single minded special purpose algorithms running at any given instant. This allows peripheral 10 to exclusively attend to sensor data collection and processing whereas the general purpose computer must prioritize its many tasks. The peripheral 10 is enabled by the microcontroller 30, based on the rules within the firmware instructions, to report data or conclusions, and/or store data and report conclusions if appropriate, rather than just report raw data. The microcontroller 30 may then continue the loop until the next conclusion is reached and reported or until the peripheral 10 is powered down. This relieves the need for an operating system as present in the computer 20 that the peripheral 10, such as the PMSS, would be attached to. Such computers 20 are general purpose and run an operating system that allows numerous tasks to be created, stopped or started by inputs from the operator or outside sources such as the Internet, external devices or the peripheral 10.

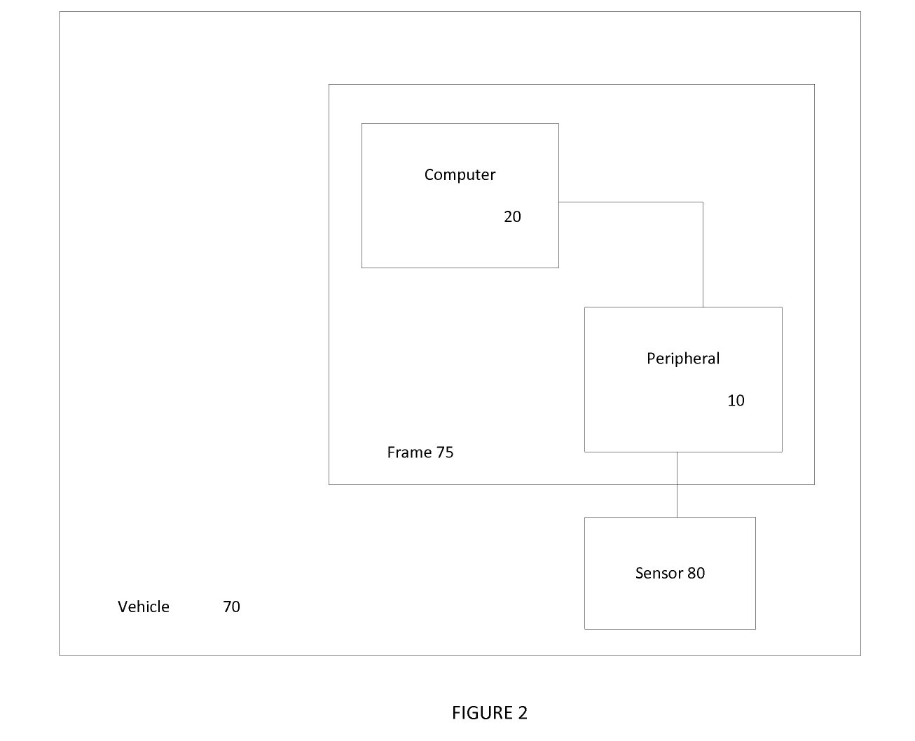

As shown in FIG. 2, the vehicle 70 may have one or more sensors 80 to measure some physical parameter of the vehicle environment or operational status of the vehicle 70 where the sensor 80 is installed. Examples of parameters to measure include temperature, fuel flow, motion, location, and orientation or changes in these parameters. The sensors may take these measurements and report the results to the peripheral 10. Sensors 80 may be incorporated into peripheral 10, as shown in FIGS. 1A and 1B; or be outside of peripheral 10, as shown in FIG. 2, and configured to send signals to peripheral 10.

The peripheral 10 also includes a communications link 60 to interface with the computer 20 to transfer information. USB, Serial, Parallel, Bluetooth, and Wi-Fi are just a few of the many protocols which could be used to implement the communications link. There may also be one or many input and output interfaces in general purpose I/O (GPIO) 90. For example in an embodiment of the invention further described below there are about sixteen programmable analog and digital ports that can be programmed to accept or send data in the GPIO 90 hardware block. Further communications link 60, in this embodiment is a USB formatted communications port that powers peripheral 10, receives configuration commands and outputs three axis acceleration data.

The peripheral 10 may execute one or more firmware algorithms to cause the microcontroller 30 to perform a desired set of operations to collect, process, and report sensor conclusions representing certain parameters. A software program operating on the computer 10 may be used to receive conclusions from the microcontroller 30 and act on the conclusions reported.

In an alternative embodiment of the peripheral 10, a storage medium may be present and used to save data for later access and review. The storage medium could be a hard drive, EEprom, SD card, or other similar storage media

The components of peripheral 10 may be implemented in a printed circuit board, integrated circuit, system on chip or other physical device which allows the functionality described above to be combined in a modular manner without respect to size of the devices (microcontroller, sensor, etc.), produced, and mounted in vehicle 70. The microcontroller 30, sensor 80 and communications link 60 may be internal to the peripheral 10 and share common communication protocols. The components of the peripheral 10 may be “plug and play” and can easily be replaced or substituted during the peripheral design phase or as discrete items configured during product assembly. In some embodiments the peripheral 10 may have one or more sockets to receive one or more external sensors 80 dependent on the data collection requirements

The microcontroller 30 can accept data from the sensor 80 through GPIO 90 in digital or analog mode. The microcontroller 30 then processes and formats the data for transmission per the firmware instructions. In an embodiment of the invention a COTS microcontroller designed to accept analog and digital data and to communicate digital data over a common interface protocol may be used, which allows for the design of a microcontroller module. The module may exist as discrete components or as a data set which can be implemented in the layout of a Printed Circuit Board, a Field Programmable Gate Array, or such other physical media as may be produced and mounted to perform the peripheral functions. Similarly, a sensor module may be designed and implemented in the same media as the microcontroller 30 and connected to the microcontroller 30, and the communication link module may be designed and implemented in the same media as the microcontroller 30 and connected to the microcontroller 30.

The microcontroller 30 may be combined with any sensor 80 which can be configured to communicate using the standard protocol implemented in the microcontroller module and applied to the application to extend the functionality of the computer 10.

The peripheral 10 combines programmable microcontrollers 30 with analog (dumb) and/or digital (smart) sensors 80 for application as an extension of the computer 20's computing resources. The peripheral 10 can easily be designed to collect data with very high rates that would otherwise tie up a processor core in a computer 10 full time and completely occupy the interface buses in MGPC laptops or single board computers such as those used for mobile computing. By using the peripheral 10, data can be collected, stored, processed, and conclusions reported to the computer 20 in a timely but non-disruptive/priority basis.

Microcontrollers 30 can be designed to use significantly less energy that general purpose computers because limited software functionality is implemented (i.e. no operating system is needed). This allows the use of very small memories 50, and limited communications interfaces (possibly a single communications link 60). When combined with a smart digital sensor 80 the microcontroller 30 can ‘sleep’ until a threshold is crossed and then begin the software process. If the computer 10 was doing this on its own, other critical mission programs would be disabled.

The peripheral according to the invention can be used in situations other than computers 10 in vehicles. For example product transport recorders in which environmental factors such as temperature, humidity, location and shock may be of interest and might be reported to a general purpose computer communicating these factors to a data collection point or logging them for later review/analysis. Examples of various embodiments of the system according to the invention follow.

In one embodiment of the invention the sensor 80 in the peripheral 10 is one or more accelerometers, and using input from the accelerometers, one or more micro controllers 30 determine motion of the peripheral 10 by one or more algorithms. The peripheral 10 is mounted to the vehicle 70 by a system of brackets to a frame 75, which may include mounting brackets or a platform for computer 10.

As an example peripheral 10 may be used for motion detection. In such an embodiment sensors 80 include one or more accelerometers, for example three accelerometers in a single package including three MEMS (micro electrical mechanical systems) and an electronics package to process and digitize the three signals output by sensors 80. Microcontroller 30 may include one or more microprocessors 40, which may be single or multi-core. Microcontroller 30 accepts the accelerometer data through GPIO 90 that is integrated with the microprocessor 40, memory 50 and other functions on the micro controller 30. Several algorithms are used to process the data and communicate to computer 10 which may share the same mounting bracket frame 75, which may be a frame or platform.

The system can also serve to reduce occurrences of distracted driving by turning off the computer 20 screen when the vehicle is moving. In this embodiment, motion of the system can be derived from acceleration of the peripheral 10 in one to three axes depending on the mounting strategy and desired function of the system. An algorithm may be used to determine if the motion represents motion of the vehicle representing driving. An algorithm also communicates to the computer 20 that the vehicle 70 is in motion and a program deployed in the computer 20 receives the report of vehicle 70 motion. An algorithm may then turn off the screen of the computer 20 when the vehicle 70 is moving to reduce operator distractions. Likewise the screen would be turned on when the vehicle 70 is stopped. An algorithm may disable or enable other computer 20 features when the vehicle 70 is determined to meet desired operational parameters.

In an alternative embodiment the system according to the invention can be used for accident emergency reporting. An algorithm may be used which determines if acceleration in one to three axes represents an abnormal incident. In such a case, an algorithm activates when such an abnormal event occurs and data is stored for forensic analysis, and a communication is sent to the computer 20 that the abnormal event has taken place.

In yet another alternative embodiment of the invention the system can be used for high frequency data collection for accident forensics. In this embodiment an algorithm is activated when an abnormal event occurs that reconfigures the accelerometer, for example to change the data collection rate or reconfigure for tilt analysis.

In another alternative embodiment of the invention, driver performance data may be collected. An algorithm may be implemented to collect vehicle acceleration in one, two or three axes over time to determine the operator(s) performance. This data could be analyzed in real time to reduce storage or it could be stored for later retrieval and analysis, for example an algorithm may be implemented to determine rates of acceleration from and to a stop which is related to fuel usage or an algorithm may be implemented to determine g-forces in turns which may be related to safe fleet operation.

Instead of, or in addition to, accelerometer(s) as the sensor 80, a GPS receiver may be used in the peripheral 10. In this embodiment of the invention the combination of one or more GPS receivers with one or more micro controllers can determine motion of the peripheral 10 by one or more algorithms when the peripheral 10 is mounted to the vehicle 70 by a system of brackets, including the computer 10 mounting brackets.

The peripheral 10 with a GPS receiver can be used to reduce distracted driving by turning off the computer 20 screen when the vehicle 70 is moving. Motion of the peripheral 10 is derived from change in location reported by the GPS unit to the microcontroller. An algorithm is used to parse and select the appropriate data for the determination. The NEMA GPS format used by many systems reports speed and direction of travel as well as GPS coordinates. An algorithm may be used to determine if the motion represents motion of the vehicle 70 representing driving and an algorithm may be used to communicate to the computer 20 that the vehicle 70 is in motion. A program may be deployed in the computer 20 to receive the report of vehicle 70 motion. An algorithm in the computer 20 may turn off the screen when the vehicle 70 is moving to reduce operator distractions. Likewise the screen can be turned on when the vehicle 70 is stopped. An algorithm may disable or enable other computer 20 features when the vehicle is determined to meet desired operational parameters.

The peripheral 10 with a GPS receiver can also be used for accident emergency reporting. A button or other input device may be used by the operator or provided by the vehicle 70 to identify an abnormal incident. An algorithm may be activated when an abnormal event occurs and data may be stored for forensic analysis. An algorithm may be used to communicate to the computer 20 that an abnormal event has taken place. If such an event occurs the peripheral 10 records locations of the actions. When any of the operations or decision points above occurs the peripheral 10 can store location data (e.g. GPS coordinates, speed, direction of travel) and an algorithm may be used to report or store the data.

The peripheral 10 with a GPS receiver can also be used for driver performance data collection. An algorithm may be implemented to collect vehicle acceleration and direction of travel from changes in location or derived data from the GPS over time to determine the operator(s) performance. The sampling rate of a GPS System is typically 1 sample/second although some high performance systems can sample 10 times/second. This data could be analyzed in real time to reduce storage or it could be stored for later retrieval and analysis. An algorithm may be implemented to determine rates of acceleration from and to a stop which is related to fuel usage, and/or an algorithm may be implemented to determine g-forces in turns which may be related to safe fleet operation.

The peripheral 10 with a GPS receiver can also be used for reporting location information to the computer 20 on request from the computer 20. Programs running on the computer 20 may require GPS location data. In the case where the computer 20 does not have a GPS built in or cannot provide the processing resources the peripheral 10 configured with GPS could provide the data.

In alternative embodiments of the invention, on board diagnostics (OBD) interfaces to the vehicle 70 onboard control, such as OBDII, can be brought to the microcontroller 30 through an interface that parses the control codes coming from sensors 80 built into the vehicle 70. The combination of the parsing interface with one or more micro controllers to determine motion of the peripheral 10 by one or more algorithms when mounted to vehicle 70 by a system of brackets, including the computer 10 mounting brackets.

The system using an OBD interface can be used to reduce distracted driving by turning off the computer 10 screen when the vehicle 70 is moving. Motion of the peripheral 10 will be derived from the speed reported over the OBDII interface from vehicle sensors 80 and an algorithm will be used to parse and select the appropriate data for the determination for motion forward or in reverse. An algorithm may be used to determine if the motion represents motion of the vehicle 70 representing driving and an algorithm may be used to communicate to the computer 10 that the vehicle is in motion. A program may be deployed in the computer 10 to receive the report of vehicle 70 motion and an algorithm may turn off the screen when the vehicle 70 is moving to reduce operator distractions. Likewise the screen would be turned on when the vehicle 70 is stopped. An algorithm may disable or enable other computer 20 features when the vehicle 70 is determined to meet desired operational parameters. An algorithm may be used to detect reverse motion (backing up). The peripheral 10 could send a report to the computer 20 to turn on a display or backup cameras if connected to the computer 20; if not, the data could be switched to the computer 20.

The peripheral 10 using an OBD interface can be used for accident emergency reporting. Data provided by the vehicle may be used by an algorithm to identify an abnormal incident (for example air bag deployment or sudden change in speed). An algorithm may be activated when an abnormal event occurs and data may be stored for forensic analysis and an algorithm may be used to communicate to the MGPC that an abnormal event has taken place and the data collected.

The system using an OBD interface can be used for driver performance data collection. An algorithm may be implemented to collect vehicle acceleration from changes in speed reported on the OBDII interface over time to determine the operator(s) performance. This data could be analyzed in real time to reduce storage or it could be stored for later retrieval and analysis. An algorithm may be implemented to determine rates of acceleration from and to a stop which and fuel usage which is also reported on the OBDII.

In an alternative embodiment of the invention the sensor 80 may be a nine degree of freedom Inertial Measurement & Location System (IMS) which are available on small integrated circuit chips using Micro Electrical Mechanical System (MEMS) technology. Combined with one or more microcontrollers peripheral 10 can be implemented to locate the vehicle 70 with or without GPS signals. In major metropolitan areas GPS signals may be blocked by tall buildings or the buildings may reflect the signal creating multi path problems that effectively disable the GPS system. In these cases IMS may be used to provide location data.

In an alternative embodiment of the invention the sensor 80 may be biometric and RF sensors such as a finger print scanner or RFID chip reader to provide positive identity for software security purposes on the computer 10. These same sensors 80, or a keypad, could be used to secure the computer 10 and allow release from its dock (mounting bracket).

Other sensors 80 that could be used in association with an embodiment of the invention include: a thermocouple; an alcohol detector; a gas detector (such as a CO detector); a light meter; an acoustic detector (without regard to the acoustic wavelength); a distance detector; a tilt detector; a millimeter wave detector; an IR or thermal signal or image detector; a camera optimized for biometric scanning; a biometric pulse detector; a rotational rate or gyroscopic force detector; a magnetometer for determining direction of travel versus the earth's magnetic field; or a radiation detector such as a Geiger counter. Uses of these sensors 80 are described below.

Such sensors 80 provide many potential functions. For example, a finger print scanner may be used to provide positive identification of the computer operator, another person, or a victim or patient. A RFID chip reader may be used to determine if an authorized user is within a preset distance from the computer, and if not, a security protocol may be implemented such as locking access to the computer 20 and blanking the screen. A keypad may be used to require entry of a code to enable access to the computer 20.

The sensor 80 could be a thermocouple which would provide temperature measurements inside or outside of the vehicle 70, and if the temperature were to fall outside of a defined range a message could be sent or preventative action taken. The sensor 80 could be an alcohol detector which may be used for field sobriety testing or verifying the presence of alcohol in a liquid.

The sensor 80 may be a gas detector which may be used to sense the presence of a target gaseous material (for example chlorine from a rail or industrial accident). Further the sensors 80 could be plug and play into a socket; each sensor 80 being for a different target material; or multiple sensors 80 might be used at the same time. The gas detector could be a CO detector which may be used as a safe guard to provide an alarm or corrective action if Carbon Monoxide above set levels is detected inside the vehicle 70. In severe cold weather K9 police units are often left idling for long periods to protect the K9. Wind and snow conditions could cause CO hazards for the animal. When detected a message may be sent or corrective action taken.

The sensor 80 could be a light meter which may provide information about required computer 10 brightness settings or instrument brightness settings. The sensor 80 may be an acoustic detector without regard to the acoustic wavelength, which may be used for voice recognition or to determine the presence of an individual or animal.

The sensor 80 may be a distance detector which may be used to map road surfaces to identify maintenance issues, for example potholes when combined with a position locations system like a GPS. The sensor 80 would detect the distance from the vehicle mounting point to the road surface. The sensor 80 may be used inside the vehicle 70 to determine that all personnel in the vehicle 70 are in their proper and expected positions.

The sensor 80 may be a tilt detector to determine the orientation of the vehicle 70, for example to detect a potential roll over situation or the camber of the road surface. The sensor 80 may be a millimeter wave detector to measure distance to objects while moving or stopped. Millimeter wave detectors can detect hazardous objects hidden by some materials so the sensor 80 may be used to enhance security awareness.

The sensor 80 may detect IR or thermal signals or images and may perform analysis to report the presence or motion or other features in the signal, for example, for recognizing the computer 20 operator. The sensor 80 may be a camera optimized for biometric scanning such as facial, retina or iris recognition of the computer 20 operator. The sensor 80 may be a biometric pulse detector to detect health factors for the vehicle 70 operator or another occupant.

The sensor 80 may be a rotational rate or gyroscopic force detector to determine vehicle 70 motion parameters. The sensor 80 may be a magnetometer for determining direction of travel versus the earth's magnetic field. The sensor 80 may be a radiation detector, such as a Geiger counter, that could be used for detecting illegal or hazardous radiation sources or leaks.

The various sensors 80 described herein can be combined to obtain synergies and accuracies that cannot be obtained individually.

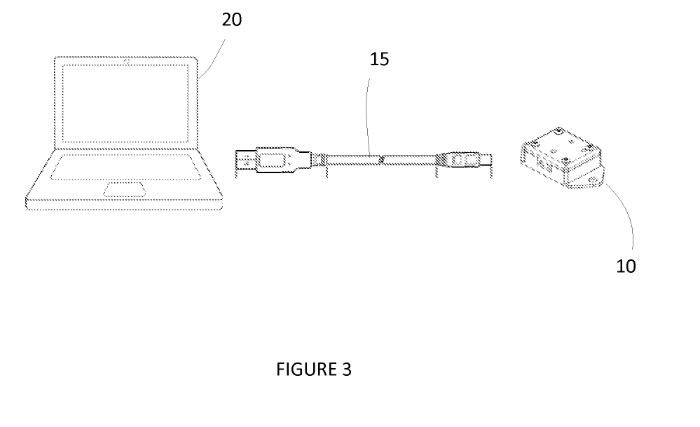

An embodiment of the invention is shown in FIGS. 3, 4A and 4B. As shown in FIG. 3, peripheral 10 is attachable to computer 20 through a communications cable 15, which in the embodiment shown in a USB to mini-USB cable. As shown in FIGS. 4A and 4B, peripheral 10 includes casing 100 having an upper casing 110 and lower casing 120. Pins 130 are used to secure upper casing 110 and lower casing 120. Board 140 includes microcontroller 30, processor 40, sensor 80, memory 50 and communications link 60, in this case a mini USB port 160. Mounting plate 150 extends from casing 100 to allow easy attachment of peripheral 10 to a frame 75 or the like. An LED status indicator light may also be included.

Such an embodiment of the invention is useful in an embodiment of the peripheral that uses sensor 80 to detect vehicle 70 motion and turns off the display of computer 20 when motion is detected.

In such an embodiment, the peripheral 10 should first be installed and configured to work with computer 20. Once installed and configured no further user interaction is needed. Peripheral 10 can remain connected to computer 20 at all times, or peripheral 10 can be connected only when required. In this embodiment, peripheral 10 receives power through the mini USB port 160, and will start automatically as soon as it receives power.

In operation, computer 10 display will blank when the vehicle 70 is moving and return to normal when the vehicle 70 is stopped. LED status indicator light will blink a color, such as green when the motion sensed is below a configured threshold and will blink a different color, such as red when the motion sensed is above the configured threshold, at which point peripheral 10 will cause computer 20's display to go black or revert to a screen server, depending on how peripheral 10 is configured.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, and/or execute acts in a different order than set out in the illustrated embodiments.

Further, in the methods taught herein, the various acts may be performed in a different order than that illustrated and described. Additionally, the methods can omit some acts, and/or employ additional acts.

These and other changes can be made to the present systems, methods and articles in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

What is claimed is:

1. A peripheral for a mobile computer mounted to a vehicle, the peripheral comprising:
a microcontroller; and
a sensor, wherein the peripheral has a communications link to the mobile computer and the peripheral is attached to the vehicle, and further wherein the microcontroller is configured to receive data from the sensor and process the data for the mobile computer.

2. The peripheral as set forth in claim 1, wherein the peripheral further comprises a discrete memory for storing data received from the sensor.

3. The peripheral as set forth claim 1, wherein the mobile computer and the peripheral are attached to the vehicle using a frame.

4. The peripheral as set forth claim 1, wherein the sensor comprises at least one of an accelerometer, a GPS receiver, an on board diagnostic system, or an inertial measurement and location system.

5. The peripheral as set forth claim 4, wherein the microcontroller is configured to use the data from the sensor to determine when the vehicle is in motion, and when the vehicle is in motion to signal the mobile computer, wherein the mobile computer is configured to turn off a screen of the mobile computer on receipt of the signal.

6. The peripheral as forth in claim 4, wherein the microcontroller is configured to use the data from the sensor to determine when an abnormal incident has occurred, and to signal the mobile computer when the abnormal incident occurred, and to store the data for later access.

7. The peripheral as set forth in claim 4, wherein the microcontroller is configured to store data from the sensor for later use in determining driver performance.

8. The peripheral as set forth in claim 1, wherein the sensor is a security system and the microcontroller is configured to use the data from the sensor to determine access to the mobile computer.

9. The peripheral as set forth in claim 8, wherein the security system is a finger print scanner for providing identification data of a person to the microcontroller.

9. The peripheral as set forth in claim 8, wherein the security system comprises at least one of a RFID chip reader for providing distance data to the microcontroller or a keypad for providing code data to the microcontroller to enable access to the mobile computer.

10. The peripheral as set forth in claim 1, wherein the sensor comprises at least one of a thermocouple for providing temperature measurement data to the microcontroller, an alcohol detector for providing field sobriety testing data to the microcontroller, a gas detector for providing data relating to a target gaseous material to the microcontroller, a light meter for providing data relating to computer brightness settings to the microcontroller, an acoustic detector for providing data relating to voice recognition to the microcontroller, a distance detector for providing mapping data relating to road surfaces to the microcontroller, a tilt detector for providing data related to orientation of the vehicle to the microprocessor, a millimeter wave detector providing data relating to distance to objects to the microcontroller, a biometric pulse detector for providing health related data to the microcontroller, a magnetometer for providing data related to direction of the vehicle travel versus earth's magnetic field, or a radiation detector for providing data relating to radiation to the microcontroller.

11. The peripheral as set forth in claim 10, wherein the gas detector is a CO detector.

12. The peripheral as set forth in claim 1, wherein the sensor detects infrared or thermal signals to provide data relating to presence of or motion of items to the processor for recognition of a computer operator.

13. The peripheral as set forth in claim 1, wherein the sensor further comprises a camera optimized for providing biometric scanning data to the microcontroller for recognition of a computer operator.

14. The peripheral as set forth in claim 1, wherein the sensor provides gyroscopic force data to the microcontroller for determining vehicle motion parameters.
